(19) United States
(12) Patent Application Publication
(10) Pub. No.: US 2016/0068646 A1
(43) Pub. Date: Mar. 10, 2016

(54) METHOD OF PRODUCING POLYURETHANE FOAM FOR COSMETIC APPLICATION AND POLYURETHANE FOAM FOR COSMETIC APPLICATION

(71) Applicant: TOYO QUALITY ONE CORPORATION, Kawagoe-shi (JP)

(72) Inventors: Fumihide Kumaki, Kawagoe-shi (JP); Jin Amano, Kawagoe-shi (JP); Ryuta Kinami, Kawagoe-shi (JP); Daisuke Yamada, Kawagoe-shi (JP); Shigetoshi Mimura, Kawagoe-shi (JP)

(73) Assignee: TOYO QUALITY ONE CORPORATION, Kawagoe-shi (JP)

(21) Appl. No.: 14/942,655

(22) Filed: Nov. 16, 2015

Related U.S. Application Data
(63) Continuation of application No. PCT/JP2014/063073, filed on May 16, 2014.

(30) Foreign Application Priority Data
May 17, 2013 (JP) 2013-105501

(51) Int. Cl. C08J 9/12; A45D 34/04; A45D 33/34

(52) U.S. Cl. CPC C08J 9/122; A45D 33/34; A45D 34/04; C08J 2375/08

(57) ABSTRACT

A method of producing a polyurethane foam for cosmetic application by machine foaming using a polyol component, a polyisocyanate component, a catalyst, a foam stabilizer and an inert gas is disclosed. The polyol component used contains 30 mass % or more of bifunctional polyol with a ratio of primary hydroxyl groups to terminal hydroxyl groups of 70% or more and a number average molecular weight of 1000 to 3000 and has an average ratio of primary hydroxyl groups to terminal hydroxyl groups in the whole polyol component of 50% or more. The polyisocyanate component is used at an isocyanate index ranging from 85 to 130. A supply of the inert gas in terms of a volume at 0° C. and 1 atm is adjusted to two to ten times a total supply of liquid materials of the polyol component, polyisocyanate component, catalyst and foam stabilizer.

### CROSS-REFERENCE TO RELATED APPLICATIONS

This application is a Continuation application of PCT Application No. PCT/JP2014/063073, filed May 16, 2014 and based upon and claiming the benefit of priority from Japanese Patent Application No. 2013-105501, filed May 17, 2013, the entire contents of all of which are incorporated herein by reference.

### BACKGROUND OF THE INVENTION

1. Field of the Invention

The present invention relates to a method of producing a sponge puff to apply cosmetics such as powdery-foundation and liquid-foundation, or a polyurethane foam for cosmetic application which is used for the application portion of cosmetic chips and the like, and a polyurethane foam for cosmetic application.

2. Description of the Related Art

The following are conventionally known as raw materials for foams for cosmetic application.

[Wet Process Polyurethane]

As application tools made from wet process polyurethane foams, for example, those disclosed in Jpn. Pat. Appln. KOKOKU Publication No. 58-189242 are known. A polyurethane polymer is dissolved in dimethylformamide, and a composition with which a pore forming agent such as polyvinylalcohol is combined is stirred. The obtained mixture is filled in a prescribed mold and gelled, and the pore forming agent is then eluted with a large amount of water to produce a wet process polyurethane foam. The cell structure of wet process polyurethane foams produced by this method is a structure like coral due to resin aggregate (hereinafter, referred to as coral-like structure). It is known that wet process polyurethane foams having such cell structure have a smooth texture and a good touch. Dimethylformamide has however a large burden on the environment, and is thus designated as Class I Designated Chemical Substances in the Pollutant Release and Transfer Register Law (PRTR Law), and an extensive use thereof is difficult. Besides, the above-mentioned method increases costs with respect to steps and raw materials. In addition, the above-mentioned wet process polyurethane foams have a coral-like cell structure, and thus when liquid-foundation is used, there are problems in that plenty of foundation infiltrates into the interior of the foam, and the amount of foundation which is not applied and is incorporated into the interior increases.

[Dry Process Polyurethane]

For common dry process polyurethane foams, a polyol with over two functional groups is used, and foaming is carried out using water as a foaming agent and low boiling compounds such as chlorofluorocarbon, dichloromethane and hydrocarbon as auxiliary foaming agent. Dry process polyurethane foams produced by this method commonly have a large average cell size of 300 μm or more. Furthermore, when water is used as a foaming agent, a urea bond generated by the reaction of water and an isocyanate works as a hard segment in a resin framework. Therefore, dry process polyurethane foams are rough and do not have a good feel.

In addition, carbonic acid gas generated by water foaming has high resin permeability. Therefore, the velocity of carbonic acid gas blowing through the cell membrane of foam to the outside is faster than the velocity of air flowing from the outside of foam, and thus the pressure in cells tends to decrease. When a cell size is reduced and flexibility is provided for foams for the purpose of improving its touch, or closed cells are increased for the purpose of reducing the permeation of liquid-foundation into foams, there are problems in that the strength of a resin framework cannot tolerate a decrease in pressure in cells, which causes foam shrinkage, and curing reaction proceeds in the condition, and the shrunk condition does not return to the original condition.

When foaming is carried out using only an auxiliary foaming agent without using water as a foaming agent, auxiliary foaming agents such as chlorofluorocarbon and dichloromethane are not suitable because of a high burden in environmental aspects, and hydrocarbon-based (such as cyclopentane) auxiliary foaming agents require heavy investments in safety measures for producing facilities because of their flammability. In addition, a foam foamed using only an auxiliary foaming agent has many closed cells, and in the case where a resin framework is softened, when the liquefaction of an auxiliary foaming agent begins by a decrease in temperature after an increase in the temperature of foams due to reaction heat, pressure in the interior of cells decreases and shrinkage then occurs. When curing reaction proceeds in the condition, a phenomenon in which the shrunk condition does not return to the original condition is produced.

An example of a method of producing dry process type cosmetic tools is disclosed, for example, in Jpn. Pat. Appln. KOKAI Publication No. 2001-354741. It is clearly mentioned that water is used as a foaming agent in this technique. In this method, water is mainly used as a foaming agent, and thus carbonic acid gas is generated, and a urea bond is formed in a molecular framework. The urea bond works as a hard segment in the framework, and thus foams tend to easily have a rough feeling and a poor feel. When a texture is improved by reducing water, an expansion ratio becomes small and density increases, and a foam to be obtained becomes hard as a product.

Japanese Patent No. 3402764 discloses a method of producing a water absorbing polyurethane foam, in which the isocyanate index is in a range between 35 and 50, and water is in a range between 1.0 and 3.0 parts by mass with respect to 100 parts by mass of polyol. In this method, water does not function as a foaming agent, and is allowed to function as a material for defoaming to communicate cells. This method can improve the water absorption and water retentivity of polyurethane foams, but is insufficient to provide a soft and smooth texture required for a cosmetic sponge puff. In addition, openings in cells become larger by communicating cells, and thus there are problems in that the amount of liquid-foundation permeated into the interior of a foam increases and the amount of liquid-foundation which can be actually used for makeup decreases at the time of applying liquid-foundation.

[NBR Latex]

Sponges for cosmetic application comprising NBR latex foam are commercially available. NBR latex foam has a cell structure with large openings because of producing problems and liquid-foundation easily permeates into the interior of sponges, and thus there is a problem in that the amount of liquid-foundation which can be actually used for makeup decreases. In addition, a feel can be improved to some extent by adjusting raw materials and cells, but it is difficult to provide a smooth texture like a wet process polyurethane.

[Silicone Foam]

Sponges made of silicone foam for applying liquid-foundation are also commercially available. Silicone foam has a closed cell structure, and thus particles constituting foundation are accumulated on the surface of the foam at the time of applying powdery-foundation, and when the foam rubs the surface of foundation, the surface of foundation is compressed, which causes a phenomenon called caking, by which the surface of foundation is solidified and the foundation cannot be taken.

### BRIEF SUMMARY OF THE INVENTION

An object of the present invention is to provide a polyurethane foam for cosmetic application, which shows less penetration of liquid-foundation, does not produce powdery-foundation caking, provides a good feel when used, and reduces a burden on the environment, at a low cost.

A method of producing a polyurethane foam for cosmetic application according to the present invention is characterized by using a polyol component, a polyisocyanate component, a catalyst, a foam stabilizer and an inert gas when producing the polyurethane foam by machine foaming, wherein;

the polyol component used contains 30 mass % or more of bifunctional polyol with a ratio of primary hydroxyl groups to terminal hydroxyl groups of 70% or more and a number average molecular weight of 1000 to 3000 and has an average ratio of primary hydroxyl groups to terminal hydroxyl groups in the whole polyol component of 50% or more;

the polyisocyanate component is used at an isocyanate index ranging from 85 to 130; and

a supply of the inert gas in terms of a volume at 0° C. and 1 atm is adjusted to two to ten times a total supply of liquid materials of the polyol component, polyisocyanate component, catalyst and foam stabilizer.

A polyurethane foam for cosmetic application according to the present invention is characterized by having a density of 60 kg/m³ to 300 kg/m³, an Asker F hardness of 30° to 70°, an airflow resistance of 2 kPa·sec/m to 250 kPa·sec/m, and a tensile strength of 50 kPa or more.

The polyurethane foam for cosmetic application according to the present invention can be produced for example by the above-mentioned production method.

According to the present invention, there can be provided a polyurethane foam for cosmetic application, which shows less penetration of liquid-foundation, does not produce powdery-foundation caking, provides a good feeling when used, and reduces a burden on the environment, at a low cost.

### BRIEF DESCRIPTION OF THE SEVERAL VIEWS OF THE DRAWING

FIG. 1 is a photograph of the cosmetic sponge puff in Example 9 taken by an electron scanning microscope at 100-fold magnification.

FIG. 2 is a photograph of the cosmetic sponge puff in Example 10 taken by an electron scanning microscope at 100-fold magnification.

FIG. 3 is a photograph of the cosmetic sponge puff in Comparative Example 10 taken by an electron scanning microscope at 100-fold magnification.

FIG. 4 is a photograph of the cosmetic sponge puff in Comparative Example 11 taken by an electron scanning microscope at 100-fold magnification.

### DETAILED DESCRIPTION OF THE EMBODIMENT OF THE INVENTION

The embodiments of the present invention will now be described.

The present inventors found that, to solve the problems of conventional foams for cosmetic application, it is preferred that a foam with high flexibility be produced by reducing a foaming agent as much as possible.

In the present invention, machine foaming is used in which an inert gas is forcedly introduced into a polyurethane material with mixing and stirring. Inert gases include noble gases such as helium, neon and argon, nitrogen gas, and dry air. Nitrogen gas or dry air is suitably used from a viewpoint of costs.

A device for machine foaming can be for continuous foaming or for batch foaming. Examples of devices for machine foaming for continuous foaming include a disk-shaped mixer such as an Oaks mixer, and a cylindrical mixer from Haas-Mondomix. Examples of devices for machine foaming for batch foaming include a desktop whisk. A continuous foaming device which produces uniform cells and does not produce pinholes easily is suitable in view of mass production.

It is preferred that the supply of inert gas in terms of volume at 0° C. and 1 atm during machine foaming be two to ten times, preferably 3 to 5 times, the total supply of polyurethane materials.

When the supply of inert gas is low, the density of polyurethane foam increases and the texture becomes hard. When the supply of inert gas to a polyurethane material is too large, a stagnant gas is formed and discharged, which causes voids and pinholes. When the supply of inert gas is above 10 times the total supply of polyurethane materials, the tendency is shown.

A polyol component in polyurethane materials in the present invention contains 30 mass % or more, preferably 50 mass % or more, of bifunctional polyol with a ratio of primary hydroxyl groups to terminal hydroxyl groups of 70% or more and a number average molecular weight of 1000 to 3000.

As a polyol component, only a bifunctional polyol with a ratio of primary hydroxyl groups to terminal hydroxyl groups of 70% or more and a number average molecular weight of 1000 to 3000 (100 mass %) may be used. When the mixture of a bifunctional polyol with a ratio of primary hydroxyl groups to terminal hydroxyl groups of 70% or more and a number average molecular weight of 1000 to 3000 and another polyol is used, the average number of functional groups in the whole polyol component is preferably 1.8 to 3.5.

For common dry process polyurethane foams, a polyol with more than two functional groups is used, and foaming is carried out using water as a foaming agent and a low boiling compound such as chlorofluorocarbon, dichloromethane or hydrocarbon as an auxiliary foaming agent. Consequently, polyurethane foams to be obtained do not have sufficient strength as a sponge puff for cosmetic application, and pinholes are generated and both appearance and a feeling when used become worse. In addition, the tensile strength of the polyurethane foam decreases by an increase in the number of functional groups in the polyol component and the foam is easily torn when used.

In the present invention, the above-mentioned problems are solved by using 30 mass % or more of polyol with two functional groups in the whole polyol component. When a polyol with two functional groups is less than 30 mass % in the whole polyol component, a low density foam containing fine cells is not obtained, and foam density increases, hardness increases, and a feel becomes worse.

In machine foaming, types of polyol contribute largely to the expansion ratio of polyurethane foam. Specifically, the reactivity, viscosity and affinity for a polyisocyanate of a polyol affect the expansion ratio of polyurethane foam. Addition polymers with only propylene oxide, not containing ethylene oxide, have low reactivity; and thus the cells of a polyurethane foam have low stability, and lower density and softening cannot be achieved. In order that a cell shape can be stabilized and lower density and softening can be achieved, it is preferred that the ratio of primary hydroxyl groups to terminal hydroxyl groups rise to about 70% or more using a bifunctional material, and the addition-polymerization of ethylene oxide to the terminal of a polyol is effective.

For example, addition-polymerization of polypropylene oxide to an initiator in the presence of an acid catalyst (addition polymerization catalyst) prepares a bifunctional polypropylene glycol with a ratio of primary hydroxyl groups to terminal hydroxyl groups of 40% or more, and further addition of ethylene oxide thereto prepares a bifunctional polyol with a ratio of primary hydroxyl groups to terminal hydroxyl groups of 70% or more and a number average molecular weight of 1000 to 3000, thereby providing the polyol component containing 30 mass % or more of this bifunctional polyol, with an average ratio of primary hydroxyl groups to terminal hydroxyl groups in the whole polyol component of 50% or more.

By raising the ratio of primary hydroxyl groups to terminal hydroxyl groups in the polyol component, reactivity increases and cells can be maintained, and thus a foam with lower density can be obtained. Adding ethylene oxide to the initiator can raise the ratio of primary hydroxyl groups to terminal hydroxyl groups. Ethylene oxide adducts however have high hydrophilicity, and when water-based foundation is used, the foam is swollen and easily torn. In order to improve water resistance, it is preferred that the ratio of ethylene oxide adduct in a molecule be reduced as much as possible.

When propylene oxide is addition-polymerized, polymerization is commonly carried out using an alkali catalyst. In this case, the majority of propylene oxide is beta-cleaved to change the terminal to a secondary hydroxyl group, and the primary hydroxyl group becomes about 2%. In order to raise the ratio of primary hydroxyl groups to terminal hydroxyl groups, it is preferred that after propylene oxide is addition-polymerized, ethylene oxide be addition-polymerized thereto. It is difficult to maintain the ratio of primary hydroxyl groups to terminal hydroxyl groups and minimize the ratio of ethylene oxide added.

By contrast, as disclosed in Jpn. Pat. Appln. KOKAI Publication No. 2000-344881, as an example in the present invention, addition-polymerization of propylene oxide to an initiator in the presence of an acid catalyst such as trispentafluorophenyl borane produces a product with the increased ratio of primary hydroxyl groups to terminal hydroxyl groups, and further addition-polymerization of ethylene oxide produces a polyol component with a ratio of primary hydroxyl groups to terminal hydroxyl groups of 70% or more, preferably 90% or more, and by using this polyol component, water resistance of polyurethane foam can be improved.

In the present invention, less than 1.0 parts by mass of water with respect to 100 parts by mass of polyol may be used as a foaming agent. When water is used as a foaming agent in an auxiliary manner during machine foaming, lower density can be obtained, and thus a soft feel can be obtained. As described above, in the case of water foaming, there is a possibility of a rough feel and shrinkage; however, shrinkage can be inhibited by reducing water to less than 1.0 parts by mass, and further roughness can be decreased by reducing water to 0.7 parts by mass or less.

In addition, foaming by adding chlorofluorocarbons, dichloromethane and hydrocarbon-based auxiliary foaming agents is not restricted in the present invention. In the present invention, a foam after foaming can be subjected to crushing. In the case of a sponge puff for cosmetic application produced from materials with high closed cell tendency, there is a possibility that caking occurs at the time of applying powdery-foundation. By contrast, cells can be communicated by crushing of a polyurethane foam after foaming, and thus caking can be prevented and dimentinal stability can be maintained. In addition, air permeability and hardness can be controlled by adjusting the degree of crushing, and a material suitable for a sponge puff for cosmetic application can be produced.

The polyurethane foam for cosmetic application according to the present invention has a density of 60 kg/m³ to 300 kg/m³, an Asker F hardness of 30° to 70°, an airflow resistance of 2 kPa·sec/m to 250 kPa·sec/m, and a tensile strength of 50 kPa or more. Such polyurethane foam for cosmetic application can be produced by the method of the present invention.

The density of polyurethane foam is measured in accordance with JIS K7222. When the density of polyurethane foam is less than 60 kg/m³, a texture is rough and a feel when used is bad, cells are coarse, and the foam can be tore because resin strength cannot be maintained. When the density is above 300 kg/m³, a polyurethane foam becomes hard and loses flexibility, and can take foundation only in the form of line because the foam does not bend when taking powdery-foundation. When the density of polyurethane foam is adjusted to 60 to 300 kg/m³, these problems can be solved. In order to obtain both a soft touch and tensile strength, at which a foam is not torn when used, it is preferred that a polyurethane foam have a density of 70 to 200 kg/m³.

The hardness of a polyurethane foam is measured with an Asker F durometer. Specifically, a sample cut into a thickness of 8 mm is put on an acrylic panel, and an Asker F durometer is put thereon, and hardness after 10 seconds is read. When a polyurethane foam has an Asker F hardness of less than 30°, the bottoming feeling is generated at the time of applying foundation, which leads to pressing with finger shapes, and foundation cannot be applied with a large surface area, and thus uniform application becomes difficult. When the Asker F hardness is above 70°, a polyurethane foam is not followed to the skin, and the uniform application of foundation thus becomes difficult. A polyurethane foam more preferably has an Asker F hardness of 40° to 60° in order to achieve both a soft touch and a restoring feeling.

The airflow resistance of a polyurethane foam is measured with KES-F8-AP1 manufactured by Kato tech Co., Ltd. Specifically, a sample cut into a thickness of 8 mm is provided, and air is send to the sample at a fixed flow rate by the piston action of plunger and cylinder, and pressure drop measured by a semiconductor differential pressure gauge at the time of release to the atmosphere through the sample is evaluated as an airflow resistance. When the airflow resistance is less than 2 kPa·sec/m, liquid-foundation easily permeates into a polyurethane foam. When the airflow resistance of a polyurethane foam is above 250 kPa·sec/m, caking easily occurs at the time of applying powdery-foundation. As long as the airflow resistance of a polyurethane foam is 2 kPa·sec/m to 250 kPa·sec/m, the amount of liquid-foundation permeated can be reduced, and caking can be prevented at the time of applying powdery-foundation.

The tensile strength of a polyurethane foam is measured in accordance with JIS K6400-5. When the tensile strength is less than 50 kPa, there is a high possibility that a polyurethane foam is tore when used. The tensile strength of a polyurethane foam is preferably 70 kPa or more.

In order to obtain density, Asker F hardness, airflow resistance and tensile strength within the above-mentioned ranges, the formulation of materials is adjusted to produce a polyurethane foam.

As described above, determining polyol materials and further adjusting equipment and producing conditions can produce a polyurethane foam with a density of 60 kg/m³ to 300 kg/m³, an Asker F hardness of 30° to 70°, an airflow resistance of 2 kPa·sec/m to 250 kPa·sec/m and a tensile strength of 50 kPa or more.

A texture when a product is used as a cosmetic puff can be improved by making cells fine. The cell size can be measured in accordance with JIS K6400-1, and a preferred cell size is 250 μm or less.

Such polyurethane foam has fine cells and, unlike conventional dry process polyurethane foams, is not in the state of complete open cells, and thus the permeation of foundation into the interior of a foam can be largely reduced at the time of applying liquid-foundation.

The cell structure of foams correlates with airflow resistance and permeation of liquid-foundation. Wet process polyurethane foams and NBR latex foams have an airflow resistance of less than 2 kPa·sec/m, and liquid-foundation easily permeates. In the meantime, when the airflow resistance is above 250 kPa·sec/m, caking easily occurs at the time of applying powdery-foundation. By contrast, the polyurethane foam of the present invention produced by machine foaming has an airflow resistance of 2 kPa·sec/m to 250 kPa·sec/m, which can reduce the amount of liquid-foundation permeated.

The present invention will now be described in more detail.

A polyol component and an isocyanate component as main components, and a foam stabilizer and a catalyst as auxiliary agents are used in the present invention, and a foaming agent, a cross-linking agent, a UV absorber, a light stabilizer, a colorant, an antioxidant, an antibacterial agent and the like are added in some cases.

As a polyol component, a bifunctional polyol with a ratio of primary hydroxyl groups to terminal hydroxyl groups of 70% or more and a number average molecular weight of 1000 to 3000 is usedsingly, or the above bifunctional polyol is mixed with another polyol so that the bifunctional polyol content will be 30 mass % or more, preferably 50 mass % or more, in all the polyol component. As other polyols, a polyether polyol, a polyester polyol, a polymer polyol and the like used for producing a polyurethane foam can be used singly or in combination. Even when the above bifunctional polyol and another polyol are mixed, foaming properties and foam stability required for machine foaming are obtained as long as the average ratio of primary hydroxyl groups to terminal hydroxyl groups in all the polyol component is 50% or more.

As a polyisocyanate component, aromatic isocyanates such as tolylene diisocyanate (TDI) and diphenylmethane diisocyanate (MDI), aliphatic isocyanates such as hexamethylene diisocyanate (HDI), isophorone diisocyanate (IPDI), norbornene diisocyanate (NBDI), hydrogenated diphenylmethane diisocyanate (MDI), hydrogenated xylylene diphenylmethane diisocyanate (XDI) used to produce a polyurethane foam can be used singly or in combination.

MDI and TDI are commonly used; however, aliphatic isocyanates can be also used for the purpose of preventing yellowing due to ultraviolet rays.

In the case of production by machine foaming, it is preferred that the isocyanate component has high viscosity to maintain the stability of the foams generated. An increase in the size of cells due to foam coalescence can be prevented by fast resinification reaction, and thus a MDI-based material is preferably used.

In MDI-based materials, an increase in the amount of polymeric MDI causes an increase in the number of functional groups, and strech property deteriorates, and thus monomeric MDI is preferably used. Pure monomeric MDI is a solid at ordinary temperature, and thus is used after changed to a liquid by warming. Monomeric MDI can be changed to a liquid at ordinary temperature with its characteristics maintained for example by pre-polymerization by partial reaction with a polyol, and carbodiimide modification. The latter is suitable because production can be carried out with a simple device.

As a foam stabilizer, for example, a silicone-based foam stabilizer for polyurethane foams can be used, in which a polyether bond is combined with a polysiloxane bond. Particularly, a silicone-based foam stabilizer sold for machine foaming can be suitably used.

As a catalyst, metal catalysts such as tin-based and bismuth-based catalysts and tertiary amine catalysts can be used singly or in combination. A temperature sensitive catalyst may be used to prevent the start of curing during stirring.

As a foaming gas, an inert gas is used and forcedly mixed with liquid materials at the time of machine foaming. As the inert gas, noble gases (helium, neon, argon etc.), nitrogen gas and dry air can be used. Nitrogen gas or dry air is suitably used in view of costs.

A foaming agent is used in an auxiliary manner. As the foaming agent, water which develops carbon dioxide by reaction with a polyisocyanate is preferably used in a small amount. The proportion of water combined as a foaming agent is preferably less than 1.0 parts by mass with respect to 100 parts by mass of polyol.

As a foaming agent, dichloromethane, various chlorofluorocarbon materials, cyclopentane, methyl formate, liquefied carbon dioxide and the like may be used, which are used for common polyurethane foaming.

As a cross-linking agent, for example, low molecular weight polyols such as 1,4-butanediol, trimethylolpropane, ethyleneglycol and diethyleneglycol, and polyamines such as methylenebisdiphenylpolyamine and tolylene diamine can be used.

As a UV absorber, for example, titanium dioxide, zinc oxide, benzotriazole-based materials, benzophenone-based materials and the like can be used singly or in combination.

As a light stabilizer, for example, those such as hindered amine-based materials can be used.

As a colorant, for example, one in which a pigment is dispersed in a polyol material may be used or a dye may be used.

As an antioxidant, for example, hindered phenol-based materials, phosphite ester materials and the like can be used.

As an antibacterial agent, known antibacterial agents such as silver-supporting zeolite, silver ion-containing aqueous solutions, inorganic antibacterial agents or organic antibacterial agents (zinc pyrithione, thiabendazole etc.) can be used.

The above-mentioned materials are stirred with an inert gas forcedly mixed in by machine foaming to initiate the reaction of polyurethane while forming cells.

A polyurethane reaction solution discharged from a foaming device is subjected to slab forming, a cured polyurethane foam is cut into a prescribed shape, and a cosmetic sponge puff can be then obtained by polishing its ends to a round shape.

A polyurethane reaction solution discharged from a foaming device is introduced into a mold and can be also subjected to mold forming.

The cross-sectional shape of a mold should have a size larger than that of a prescribed cosmetic puff.

The foamed article thus obtained can be then a cosmetic sponge puff by polishing its ends to a round shape.

A polyurethane reaction solution may be introduced into a tubular mold, the cross-sectional shape of which has a size larger than that of a prescribed cosmetic puff, and a bar-like foam can be also produced.

The bar-like article thus obtained is cut into a prescribed thickness, and a cosmetic sponge puff can be then obtained by polishing its ends to a round shape.

A sheet-like foam with a fixed thickness can be also produced by uniformly applying liquid materials yielding polyurethane by reaction onto a release sheet, and then putting an additional release sheet on the top side.

The sheet-like article thus obtained is stamped out in a prescribed shape, and a cosmetic sponge puff can be obtained by polishing its ends to a round shape.

### Examples 1 to 3 and Comparative Examples 1 to 5

Polyurethane foams for cosmetic application were produced using materials comprising various polyols using a disk-shaped Oaks mixer by machine foaming, and the ease of incorporation of an inert gas, i.e. the miniaturization of cell size, the lower density of foams, and the tear tendency of foams were examined, and a polyol suitable for a polyurethane foam for cosmetic application was investigated.

### Example 1

A bifunctional polypropylene glycol with a ratio of primary hydroxyl groups to terminal hydroxyl groups of about 70% was prepared by addition-polymerization of propylene oxide to an initiator with two functional groups in the presence of an acid catalyst (addition polymerization catalyst), and a bifunctional polyol (Polyol A) with a ratio of primary hydroxyl groups to terminal hydroxyl groups of 92% and a number average molecular weight of 1400 was further prepared by addition of ethylene oxide.

A polyol, a cross-linking agent, a foam stabilizer, an amine catalyst (urethane reaction catalyst) and a polyisocyanate were provided in accordance with the formulation in Table 1. These materials are all in a liquid form. Water as a foaming agent is not used.

TABLE 1

| | | | |
|---|---|---|---|
| Polyol | Polyol A | 100 | parts by mass |
| Cross-linking | Diethylene glycol | 3 | parts by mass |
| agent | | | |
| Foam stabilizer | Toray Dow Corning | 5 | parts by mass |
| | Silicone SZ1956 | | |
| Amine catalyst | Tosoh Corporation | 0.3 | parts by mass |
| | B41 | | |

| | | |
|---|---|---|
| Polyisocyanate | Nippon | Isocyanate Index 100 |
| | Polyurethane | |
| | Coronate 69 (MDI) | |

A mixed material obtained by combining materials other than the polyisocyanate was continuously supplied to an Oaks mixer, and nitrogen gas was supplied. While reacting the material with the polyisocyanate in the Oaks mixer, the obtained mixture was discharged and cured at 100° C. for 7 minutes to produce a polyurethane foam for cosmetic application.

At this time, the total supply of the above-mentioned liquid materials was 0.6 kg/min, and the supply of nitrogen gas was 1.8 L/min (in terms of volume at 0° C. and 1 atm). Assuming that the specific gravity of the liquid materials is 1, (the supply of nitrogen gas) is 3 times (the total supply of the liquid materials).

### Example 2

A polyol (Polyol B) with a ratio of primary hydroxyl groups to terminal hydroxyl groups of 80% and a number average molecular weight of 2400 was prepared by addition-polymerization of propylene oxide to an initiator with two functional groups in the presence of an alkali catalyst, and further addition-polymerization of ethylene oxide.

Materials were provided in accordance with the same formulation as in Table 1 except that Polyol B was used in place of Polyol A. A polyurethane foam for cosmetic application was produced in the same manner as in Example 1.

### Comparative Example 1

A polyol (Polyol C) with a ratio of primary hydroxyl groups to terminal hydroxyl groups of about 2% and a number average molecular weight of 3000 was prepared by addition-polymerization of propylene oxide to an initiator with 3 functional groups in the presence of an alkali catalyst.

Materials were provided in accordance with the same formulation as in Table 1 except that Polyol C was used in place of Polyol A. A polyurethane foam for cosmetic application was produced in the same manner as in Example 1.

### Comparative Example 2

A polyol (Polyol D) with a ratio of primary hydroxyl groups to terminal hydroxyl groups of about 2% and a number average molecular weight of 2000 was prepared by addition-polymerization of propylene oxide to an initiator with two functional groups in the presence of an alkali catalyst.

Materials were provided in accordance with the same formulation as in Table 1 except that Polyol D was used in place of Polyol A. A polyurethane foam for cosmetic application was produced in the same manner as in Example 1.

### Comparative Example 3

A polyol (Polyol E) with a ratio of primary hydroxyl groups to terminal hydroxyl groups of 73% and a number average molecular weight of 5000 was prepared by addition-polymerization of propylene oxide to an initiator with 3 functional groups in the presence of an alkali catalyst, and further addition-polymerization of ethylene oxide.

Materials were provided in accordance with the same formulation as in Table 1 except that Polyol E was used in place of Polyol A. A polyurethane foam for cosmetic application was produced in the same manner as in Example 1.

### Comparative Example 4

A polyol (Polyol F) with a ratio of primary hydroxyl groups to terminal hydroxyl groups of 30% and a number average molecular weight of 3300 was prepared by addition-polymerization of propylene oxide to an initiator with 3 functional groups in the presence of an alkali catalyst, and further addition-polymerization of ethylene oxide.

Materials were provided in accordance with the same formulation as in Table 1 except that Polyol F was used in place of Polyol A. A polyurethane foam for cosmetic application was produced in the same manner as in Example 1.

### Example 3

A polymer polyol (Polymer polyol A) was prepared as a part of a polyol component by graft-polymerizing acrylonitrile with a polyether polyol with 3 functional groups and a number average molecular weight of 5000. A mixture (Polyol mixture A) with an apparent number average molecular weight of 3560, an apparent average number of functional groups of 2.6 and an average ratio of primary hydroxyl groups to terminal hydroxyl groups of 55% was provided by mixing 40 parts by mass of Polyol A (used in Example 1) and 60 parts by mass of Polymer polyol A.

Materials were provided in accordance with the same formulation as in Table 1 except that Polyol mixture 1 was used in place of Polyol A. A polyurethane foam for cosmetic application was produced in the same manner as in Example 1.

### Comparative Example 5

A mixture (Polyol mixture B) with an apparent number average molecular weight of 4280, an apparent average number of functional groups of 2.8, and an average ratio of primary hydroxyl groups to terminal hydroxyl groups of 42% was provided by mixing 20 parts by mass of Polyol A and 80 parts by mass of Polymer polyol A.

Materials were provided in accordance with the same formulation as in Table 1 except that Polyol mixture B was used in place of Polyol A. A polyurethane foam for cosmetic application was produced in the same manner as in Example 1.

The polyurethane foams for cosmetic application produced in Examples 1 to 3 and Comparative Examples 1 to 5 were evaluated for foam formability, apparent density, tensile strength and average cell size. The results are shown in Table 2.

TABLE 2

| | | | Comparative | Comparative | Comparative | Comparative | | Comparative |
|---|---|---|---|---|---|---|---|---|
| | Example 1 | Example 2 | Example 1 | Example 2 | Example 3 | Example 4 | Example 3 | Example 5 |
| Polyol | A | B | C | D | E | F | Mixture A | Mixture B |
| Number of | 2 | 2 | 3 | 2 | 3 | 3 | — | — |
| functional groups | | | | | | | | |
| Number average | 1400 | 2400 | 3000 | 2000 | 5000 | 3300 | — | — |
| molecular weight | | | | | | | | |
| Ratio of primary | 92 | 80 | 2 | 2 | 73 | 30 | 55 | 42 |
| hydroxyl groups | | | | | | | | |
| to terminal | | | | | | | | |
| hydroxyl groups | | | | | | | | |
| (%) | | | | | | | | |
| Supply of liquid | 600 | 600 | 600 | 600 | 600 | 600 | 600 | 600 |
| materials | | | | | | | | |
| Supply of | 1.8 | 1.8 | 1.8 | 1.8 | 1.8 | 1.8 | 1.8 | 1.8 |
| nitrogen (L/min) | | | | | | | | |
| Volume ratio of | 3 | 3 | 3 | 3 | 3 | 3 | 3 | 3 |
| nitrogen/liquid | | | | | | | | |
| Foam formability | good | good | not foamed | not foamed | good | cell | good | cell |
| | | | | | | coalescence | | coalescence |
| Apparent density | 180 | 210 | — | — | 220 | 400 | 200 | 350 |
| (kg/m³) | | | | | | | | |
| Tensile strength | 80 | 70 | — | — | 30 | 65 | 85 | 80 |
| (kpa) | | | | | | | | |
| Average cell size | 186 | 230 | — | — | 240 | 1000 | 200 | 500 |
| (μm) | | | | | | | | |

The following are found from Table 2.

When polyols in which the average ratio of primary hydroxyl groups to terminal hydroxyl groups is low are used like Comparative Examples 4 and 5, cell coalescence easily occurs due to slow reaction, and a polyurethane foam to be obtained has a large cell size and high density. When a polyol with an average ratio of primary hydroxyl groups to terminal hydroxyl groups of 50% or more is used, a polyurethane foam to be obtained has a small cell size and low density.

As to an initiator used to synthesize a polyol, one with two functional groups and one with three functional groups are compared. When using an initiator with two functional groups, a polyurethane foam to be obtained has higher tensile strength and is not more easily tore. When Examples 1 and 2, in which an initiator with two functional groups is used to synthesize a polyol, are compared, the average cell size of polyurethane foam can be smaller in Example 1 with a ratio of primary hydroxyl groups to terminal hydroxyl groups of 92%, higher than a ratio of primary hydroxyl groups to terminal hydroxyl groups of 80% in Example 2.

When Example 3 and Comparative Example 5 using a polyol mixture are compared, the polyurethane foam obtained in Example 3 has better physical properties. That is, the polyol mixture in Example 3 contains 30 mass % or more of polyol with a ratio of primary hydroxyl groups to terminal hydroxyl groups of 70% or more and a number average molecular weight of 1000 to 3000, and has an average ratio of primary hydroxyl groups to terminal hydroxyl groups of 50% or more, and thus the polyurethane foam has a smaller average cell size and lower density.

### Examples 4 to 8 and Comparative Examples 6 to 9

When a polyurethane foam for cosmetic application was produced by machine foaming using a disk-shaped Oaks mixer, influences on the physical properties of a polyurethane foam by the amount of polyisocyanate (isocyanate index) or the amount of inert gas were investigated.

### Example 4

Polyol A was used as a polyol component. The polyol, a cross-linking agent, water as a foaming agent, a foam stabilizer, an amine catalyst (urethane reaction catalyst) and a polyisocyanate were provided in accordance with the formulation in Table 3. Example 4 is the same as Example 1 except that water was used as a foaming agent.

TABLE 3

| | | | |
|---|---|---|---|
| Polyol | Polyol A | 100 | parts by mass |
| Cross-linking | Diethylene glycol | 3 | parts by mass |
| agent | | | |
| Foaming agent | Water | 0.6 | parts by mass |
| Foam stabilizer | Toray Dow Corning | 5 | parts by mass |
| | Silicone SZ1956 | | |
| Amine catalyst | Tosoh Corporation | 0.3 | parts by mass |
| | B41 | | |

| | | |
|---|---|---|
| Polyisocyanate | Nippon | Isocyanate Index 100 |
| | Polyurethane | |
| | Coronate 69 (MDI) | |

A mixed material obtained by combining materials other than the polyisocyanate was continuously supplied to an Oaks mixer, and nitrogen gas was supplied. While reacting the material with the polyisocyanate in the Oaks mixer, the obtained mixture was discharged and cured at 100° C. for 7 minutes to produce a polyurethane foam for cosmetic application.

At this time, the total supply of the above-mentioned liquid materials was 0.6 kg/min, and the supply of nitrogen gas was 1.8 L/min (in terms of volume at 0° C. and 1 atm). Assuming that the specific gravity of the liquid material is 1, (the supply of nitrogen gas) is 3 times (the total supply of the liquid materials).

### Example 5

A polyurethane foam for cosmetic application was produced in the same manner as in Example 4 except that the isocyanate index of the polyisocyanate was changed to 90.

### Example 6

A polyurethane foam for cosmetic application was produced in the same manner as in Example 4 except that the isocyanate index of the polyisocyanate was changed to 110.

### Example 7

A polyurethane foam for cosmetic application was produced in the same manner as in Example 4 except that (the supply of nitrogen gas supplied) was 2.3 times (the total supply of the liquid materials) by adjusting the total supply of the liquid materials to 0.6 kg/min and the supply of nitrogen gas to 1.4 L/min during machine foaming.

### Example 8

A polyurethane foam for cosmetic application was produced in the same manner as in Example 4 except that (the supply of nitrogen gas) was 9.0 times (the total supply of the liquid materials) by adjusting the total supply of the liquid materials to 0.6 kg/min and the supply of nitrogen gas to 5.4 L/min during machine foaming.

### Comparative Example 6

A polyurethane foam for cosmetic application was produced in the same manner as in Example 4 except that the isocyanate index of the polyisocyanate was changed to 80.

### Comparative Example 7

A polyurethane foam for cosmetic application was produced in the same manner as in Example 4 except that the isocyanate index of the polyisocyanate was changed to 135.

### Comparative Example 8

A polyurethane foam for cosmetic application was produced in the same manner as in Example 4 except that (the supply of nitrogen gas) was 1.7 times (the total supply of the liquid materials) by adjusting the total supply of the liquid materials to 0.6 kg/min and the supply of nitrogen gas to 1.0 L/min during machine foaming.

### Comparative Example 9

A polyurethane foam for cosmetic application was produced in the same manner as in Example 4 except that (the supply of nitrogen gas) was 12.0 times (the total supply of the liquid materials) by adjusting the total supply of the liquid materials supplied to 0.6 kg/min and the supply of nitrogen gas to 7.2 L/min during machine foaming.

The polyurethane foams for cosmetic application produced in Examples 4 to 8 and Comparative Examples 6 to 9 were evaluated for apparent density, tensile strength, Asker F hardness, average cell size, airflow resistance, appearance and a feeling when used. The results are shown in Table 4.

TABLE 4

| | | | | | | Comparative | Comparative | Comparative | Comparative |
|---|---|---|---|---|---|---|---|---|---|
| | Example 4 | Example 5 | Example 6 | Example 7 | Example 8 | Example 6 | Example 7 | Example 8 | Example 9 |
| Polyol | A | A | A | A | A | A | A | A | A |
| Isocyanate | 100 | 90 | 110 | 100 | 100 | 80 | 135 | 100 | 100 |
| index | | | | | | | | | |
| Volume ratio | 3 | 3 | 3 | 2.3 | 9 | 3 | 3 | 1.7 | 12 |
| of | | | | | | | | | |
| nitrogen/liquid | | | | | | | | | |
| materials | | | | | | | | | |
| Apparent | 90 | 92 | 91 | 130 | 88 | 90 | 95 | 180 | 58 |
| density | | | | | | | | | |
| (kg/m³) | | | | | | | | | |
| Tensile | 80 | 75 | 83 | 90 | 72 | 62 | 106 | 103 | 50 |
| strength | | | | | | | | | |
| (kpa) | | | | | | | | | |
| Asker F | 50 | 40 | 60 | 55 | 36 | 33 | 65 | 72 | 29 |
| hardness (°) | | | | | | | | | |
| Average cell | 186 | 195 | 194 | 175 | 210 | 205 | 208 | 160 | 320 |
| size (μm) | | | | | | | | | |
| Airflow | 52.7 | 40.3 | 65.1 | 70.5 | 35.4 | 30.3 | 72.1 | 75.3 | 30.8 |
| resistance | | | | | | | | | |
| (kPa/sec) | | | | | | | | | |
| Appearance | good | good | good | good | good | sticky | good | good | outgassing |
| | | | | | | | | | large |
| | | | | | | | | | pinholes |
| Feeling when | good | good | good | good | good | bad | bad | bad | bad |
| used*1 | | | | | | | | | |

*1A feeling when used was evaluated by a feeling of resistance against the skin when a foam was used as a sponge puff and hardness when a foam was pressed.

When Examples and Comparative Examples 6 and 7 in Table 4 are compared, it is shown that physical properties, a cell size and a feeling when used required as a sponge puff can be achieved as long as the isocyanate index of the polyisocyanate is in a range between 85 and 130.

When Examples and Comparative Examples 8 and 9 in Table 4 are compared, it is shown that physical properties, a cell size and a feeling when used required as a sponge puff can be achieved as long as (the supply of nitrogen gas supplied)/(the total supply of a liquid materials) is 2 to 10 times.

### Examples 9 to 10 and Comparative Examples 10 to 12

The performance of the sponge puff for cosmetic application according to the present invention and that of conventional sponge puffs for cosmetic application were compared.

### Example 9

The polyurethane foam produced in Example 4 was cut into a thickness of 8 mm and polished, and tests were carried out using the foam as a sponge puff for cosmetic application.

### Example 10

The polyurethane foam produced in Example 4 was subjected to crushing, then cut into a thickness of 8 mm and polished, and tests were carried out using the form as a sponge puff for cosmetic application.

### Comparative Example 10

Tests were carried out using a sponge puff for cosmetic application with a thickness of 8 mm, which was obtained from a commercially available wet process-type polyurethane foam.

### Comparative Example 11

Tests were carried out using a sponge puff for cosmetic application with a thickness of 8 mm, which was obtained from a commercially available NBR latex foam.

### Comparative Example 12

Tests were carried out using a sponge puff for cosmetic application with a thickness of 8 mm, which was obtained by laminating a commercially available silicone foam with a thickness of 0.5 mm and a commercially available NBR latex foam with a thickness of 7.5 mm.

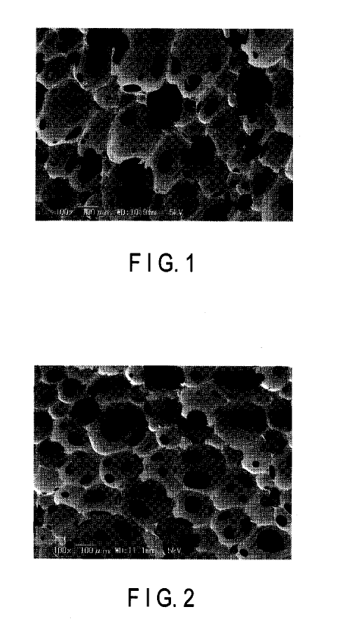

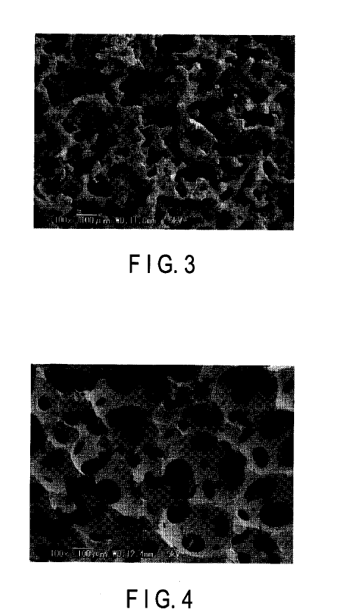

FIG. 1 shows a photograph of the sponge puff for cosmetic application in Example 9 taken by an electron scanning microscope at 100-fold magnification. FIG. 2 shows a photograph of the sponge puff for cosmetic application in Example 10 taken by an electron scanning microscope at 100-fold magnification. FIG. 3 shows a photograph of the sponge puff for cosmetic application in Comparative Example 10 taken by an electron scanning microscope at 100-fold magnification. FIG. 4 shows a photograph of the sponge puff for cosmetic application in Comparative Example 11 taken by an electron scanning microscope at 100-fold magnification.

As shown in FIG. 3, the sponge puff for cosmetic application obtained from a commercially available wet process polyurethane foam has a resin aggregation-type coral-like structure, which is a structure with a number of open holes. When liquid-foundation is applied using such sponge puff, liquid-foundation easily permeates into the sponge, and thus the amount of foundation larger than the amount actually applied to the skin is required.

As shown in FIG. 4, the sponge puff for cosmetic application obtained from a commercially available NBR latex foam has an open cell structure which has big holes on cell membranes.

The sponge puff for cosmetic application obtained from the polyurethane foam according to the present invention shown in FIG. 1 has smaller holes on cell membranes than those in FIG. 4. When such sponge puff for cosmetic application is used, the amount of liquid-foundation permeated can be smaller than that in Comparative Example 10 (wet process polyurethane foam) and Comparative Example 11 (NBR latex foam).

The sponge puff for cosmetic application obtained from the polyurethane foam according to the present invention shown in FIG. 2 is subjected to crushing after foaming, and thus has slightly larger holes on cell membranes than those in FIG. 1 but has smaller holes than those in FIG. 4. Even when such sponge puff for cosmetic application is used, the amount of liquid-foundation permeated can be smaller than that in Comparative Example 10 (wet process polyurethane foam) and Comparative Example 11 (NBR latex foam).

Next, the sponge puffs for cosmetic application in Examples 9 to 10 and Comparative Examples 10 to 12 were evaluated for apparent density, Asker F hardness, tensile strength, airflow resistance and a feeling when used, the same as in Table 4, and further abrasion resistance, the residual rate of liquid cosmetics, the penetrating depth of liquid cosmetics, and caking resistance. The results are shown in Table 5.

The abrasion resistance was evaluated in accordance with Test method 1 mentioned below, the residual rate of liquid cosmetics and the penetrating depth of liquid cosmetics were evaluated in accordance with Test method 2 mentioned below, and the caking resistance was evaluated in accordance with Test method 3 mentioned below.

Test Method 1

Using the skin surface of the polyurethane foam produced in Example 4, the operation of rubbing powdery-foundation against the skin surface by the sponge puffs for cosmetic application in Examples 9 to 10 and Comparative Examples 10 to 11 was carried out 1000 times, and the damaged condition of the sponge puffs was examined after this test.

Test Method 2

About 0.2 g of liquid-foundation was added dropwise onto the sponge puffs for cosmetic application in Examples 9 to 10 and Comparative Examples 10 to 11. The liquid-foundation attached to a sponge puff for cosmetic application was rubbed against the skin surface of the polyurethane foam 50 times in the same manner as in Test method 1. When the mass of added liquid-foundation was M₀ and the mass of liquid-foundation remaining in a sponge puff after the test was M₁, the residual rate of the liquid cosmetics R (%) was obtained by the following formula:

R (%)=(M₁/M₀)×100.

A sponge puff for cosmetic application into which liquid-foundation had permeated was cut in the longitudinal direction after this test, and the site where the liquid-foundation had penetrated was observed by color changes with visual observation. The penetrating depth (mm) from the surface was measured by putting a scale to the cross-sectional surface.

Test Method 3

Using the cosmetic sponge puffs in Examples 9 to 10 and Comparative Examples 10 to 12, the operation of taking 10 g each of powdery-foundation and rubbing the foundation against the skin was carried out until there was no powdery-foundation, and whether a caking phenomenon occur or not was examined.

TABLE 5

| Physical | | | Compar- | Compar- | |
|---|---|---|---|---|---|
| property/ | | | ative | ative | |
| perfor- | Example | Example | Example | Example | Test |
| mance | 9 | 10 | 10 | 11 | Method |
| Density | 90 | 90 | 115 | 120 | JIS K |
| (kg/M³) | | | | | 7222 |
| Asker F | 50 | 45 | 48 | 59 | Hardness |
| hardness | | | | | measure- |
| (°) | | | | | ment by |
| | | | | | Asker F |
| | | | | | durometer |
| Tensile | 80 | 75 | 191 | 80 | JIS K |
| Strength | | | | | 6400-5 |
| (kPa) | | | | | |
| Abrasion | not | not | not | not | By Test |
| Resistance | damaged | damaged | damaged | damaged | method 1 |
| (1000 times | | | | | |
| abrasion) | | | | | |
| Residual | 23 | 28 | 63 | 53 | By test |
| rate of | | | | | method 2 |
| liquid | | | | | |
| cosmetics | | | | | |
| (%) | | | | | |
| Penetrating | 1.5 | 2 | 6 | 5 | By test |
| depth (mm) | | | | | method 2 |
| Caking | no caking | no caking | no caking | no caking | By test |
| resistance | | | | | method 3 |
| Feeling | good | good | good | slightly | *1 |
| when | | | | rough | |
| used | | | | | |
| Airflow | 52.7 | 3.45 | 0.52 | 0.72 | Pressure |
| resistance | | | | | drop |
| | | | | | measure- |
| | | | | | ment by |
| | | | | | KES- |
| | | | | | F8-AP |
| | | | | | (manu- |
| | | | | | factured |
| | | | | | by Kato |
| | | | | | tech Co., |
| | | | | | Ltd.) |

It was verified that when the cosmetic sponge puffs in Examples 9 to 10 were used to apply liquid-foundation, the amount of liquid-foundation which remained in the interior of a sponge puff and could not be used (residual rate and penetrating depth) could be smaller than that of the cosmetic sponge puffs in Comparative Examples 10 to 11. When the cosmetic sponge puffs in Examples 9 to 10 were used to apply powdery-foundation, the cosmetic sponge puffs could be used to the finish without caking. About a feeling when used, roughness was slightly felt in the cosmetic sponge puff in Comparative Example 11; however, in Examples 9 to 10, Comparative Example 10 and Comparative Example 12, roughness was not felt easily and there was a comfort texture.

What is claimed is:

1. A method of producing a polyurethane foam for cosmetic application by machine foaming using a polyol component, a polyisocyanate component, a catalyst, a foam stabilizer and an inert gas, wherein:
the polyol component used contains 30 mass % or more of bifunctional polyol with a ratio of primary hydroxyl groups to terminal hydroxyl groups of 70% or more and a number average molecular weight of 1000 to 3000 and has an average ratio of primary hydroxyl groups to terminal hydroxyl groups in the whole polyol component of 50% or more;
the polyisocyanate component is used at an isocyanate index ranging from 85 to 130; and
a supply of the inert gas in terms of a volume at 0° C. and 1 atm is adjusted to two to ten times a total supply of liquid materials of the polyol component, polyisocyanate component, catalyst and foam stabilizer.

2. The method according to claim 1, wherein addition-polymerization of polypropylene oxide to an initiator in presence of an acid catalyst prepares a bifunctional polypropylene glycol with a ratio of primary hydroxyl groups to terminal hydroxyl groups of 40% or more, and further addition of ethylene oxide thereto prepares a bifunctional polyol with a ratio of primary hydroxyl groups to terminal hydroxyl groups of 70% or more and a number average molecular weight of 1000 to 3000, thereby providing the polyol component containing 30 mass % or more of the bifunctional polyol and having an average ratio of primary hydroxyl groups to terminal hydroxyl groups in the whole polyol component of 50% or more.

3. The method according to claim 1, wherein less than 1.0 parts by mass of water is used as a foaming agent with respect to 100 parts by mass of the polyol component.

4. The method according to claim 1, wherein the polyurethane foam is subjected to crushing after foaming.

5. A polyurethane foam for cosmetic application produced by the method according to claim 1, wherein the polyurethane foam has:
a density of 60 kg/m³ to 300 kg/m³,
an Asker F hardness of 30° to 70°,
an airflow resistance of 2 kPa·sec/m to 250 kPa·sec/m, and
a tensile strength of 50 kPa or more.
